(19) United States
(12) Patent Application Publication
(10) Pub. No.: US 2024/0354855 A1
(43) Pub. Date: Oct. 24, 2024

(54) PLATFORM AND CARBON OFFSET APPLICATIONS FOR GREEN SHARE FUND COMPONENTS

(71) Applicant: Janus Henderson Investors US LLC, Denver, CO (US)

(72) Inventors: Ashwin G. Alankar, Denver, CO (US); Myron S. Scholes, Atherton, CA (US); Philip Z. Maymin, Greenwich, CT (US)

(73) Assignee: Janus Henderson Investors US LLC, Denver, CO (US)

(21) Appl. No.: 18/303,061

(22) Filed: Apr. 19, 2023

(51) Int. Cl. G06Q 40/06; G06Q 30/018

(52) U.S. Cl. CPC G06Q 40/06; G06Q 30/018

(57) ABSTRACT

Embodiments are directed to a platform for calculating a portfolio carbon footprint for fund components and integrated carbon offset retirement. The platform can also calculate and resolve carbon offsets green share classes for funds. A recommendation engine is configured to assess, predict, and recommend green share allocations for investors.

### BACKGROUND

Extant technology for fund investors has no technological platform to create a vehicle that provides investors cost-effective access to carbon neutral versions to the investment portfolio of a 40ACT fund (mutual fund).

A market for carbon credits exists. These credits are issued by projects that remove carbon from the air or reduce future emissions, whose quality is rated by independent registries. Projects can be nature land based, such as planting trees or preserving forests, whose credits are customarily labelled green, nature ocean/marine based, such as preserving marine ecosystems, whose credits are customarily labelled blue or technology based, such as carbon capture technologies or alternative cleaner energy, whose credits are customarily labelled white. These credits can be used to offset carbon emissions from an individuals or a company's activities one for one, but credit is only rewarded when the carbon credit is retired. The standard market convention is to denote carbon credits in units of metric tons of carbon or their equivalent and to refer to a carbon footprint in units of millions of metric tons of carbon or their equivalent. If over the course of a year a company emits one ton of credit due to its operating activities, this one ton can be offset by purchasing and retiring one ton of carbon credits so that the net increase of carbon into the atmosphere is zero.

Currently, investors who seek their investment portfolio to align with their climate values and seek “green” portfolios are limited in their set of options. A “green” portfolio means a portfolio that has been constructed to reduce the carbon footprint of its holdings using blue, green, white and/or any other carbon credits. Data indicates less than 3% of mutual funds available to investors are “green”. A “green” share class would equalize the field so “green” investors have the same set of investment options as other investors. However, no conventional platform can effectively offer a “green” share class, whereby investors can access “green” portfolio versions of all mutual fund portfolios in a cost-effective, transparent, and reliable way. Nor is there a platform configured so such investors can enjoy the same set of investment options as investors who do not explicitly seek climate goals in their investment portfolios.

Fund investors have varying preferences for their portfolios that extend beyond the financial impact of their holdings. The most common such preference concerns environmental impact. Investors would prefer to pay some extra costs to reduce the carbon footprint of their holdings, but they face challenges in being able to determine the changing carbon exposure of their proportionate holdings in a fund whose investments and weights can change daily, and then researching, acquiring, and retiring the appropriate carbon offsets to match, on a continuous basis.

On the other side, fund managers who offer different share classes of the same fund must ensure that each share class holds the exact same assets: thus a “green” share class cannot hold carbon offsets whose price could change and thereby provide a different market exposure experience to one class of shares vs. the others. Fund managers also need to properly scale and adjust their carbon offsets to match their assets under management, which change both due to market fluctuations and investor flows, and their equity composition, which change with investment manager decisions.

Furthermore, different investors have different preferences for how much they would be willing to pay to decarbonize their portfolio, and even different preferences about the various types of carbon offsets available, making the problem trickier for both the investor and the fund manager. Finally, both the investor and the fund manager are exposed to the possibility of carbon offset market prices increasing significantly in the future, rendering planning and implementation even more difficult.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of an environment in which at least one of the various embodiments may be implemented;

FIG. 2 shows an embodiment of a client computer that may be included in a system such as that shown in FIG. 1;

FIG. 3 shows an embodiment of a network computer that may be included in a system such as that shown in FIG. 1;

FIG. 4 illustrates a logical architecture of a system in accordance with at least one of the various embodiments;

FIG. 5 illustrates an overview flowchart for a process in accordance with at least one of the various embodiments;

FIGS. 6A-6B-show user interfaces in accordance with at least one of the various embodiments.

### DETAILED DESCRIPTION OF THE EMBODIMENTS

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “widget controller” refers to a computer program that may be operative on a client application. Widget controllers may be downloaded and/or otherwise deployed to a client application. Widget controllers may be arranged to be operative for downloading content, monitoring consumer actions, or otherwise managing widgets located within client applications.

As used herein, the term “widget” refers to a user-interface element located in the client application. Widgets may be invisible or visible to users of the client applications. In some cases, a widget controller may generate widget “on-the-fly” before deploying content into the widget. Widgets may be adapted to reflect the operating environment of the client application that they are being hosted within. For example, in clients that support HTML and CSS a widget may be an HTML element such as a DIV, P, or the like. For client application operative in a Java environment, a widget may be a View object or Window object, and so on.

As used herein, the term “Host” may refer to an individual person, partnership, organization, or corporate entity that may own or operate one or more Platforms (e.g., web sites, mobile applications, or the like). Hosts may arrange components and tools to integrate with widget controllers, Distributed Immutable Ledger Database servers, or other platform servers.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Described are implementations of a technological platform for a carbon neutral, green share class 131 of fund portfolio 130 by an investment company registered under the Investment Company Act of 1940. The platform can be configured so that carbon offsets can be acquired by a separate entity on behalf of a share class 131 to offset the carbon footprint of the portfolio attributable to the share class 131. A service provider platform can be implemented by an external 3rd party, separate entity created to provide the service. The green share class 131 can receive a certification that the share class is carbon neutral or the ability to say that an attributable carbon footprint has been offset. In an implementation, the share class transact to pay expenses charged by the provider, with no interest or benefit in the value of the carbon offsets purchased. Once the carbon offsets have been purchased on behalf of the share class 131, the offsets can be consumed/extinguished, and reflected as such with a registry 120 associated with the carbon offset issuer/program 125 issuing the offset. The platform can be configured to calculate the amount of carbon offsets needed to reduce the carbon footprint of the portfolio attributable to the share class 131. In an implementation, the carbon offsets can be calculated in arrears on a periodic basis (e.g. monthly or quarterly) and each period, the expense can be adjusted and reflected in the share class' Net Asset Value (NAV).

A challenge is that under Act 40, every share class must hold the same assets and in the same proportion. Offsets are an asset and therefore share classes cannot hold offsets different than other share classes. Accordingly, in an implementation, a green fund service provider platform can be configured to offer different share classes that allows different share classes to offset their portfolio, while remaining compliant to the Act 40 rule stated above.

Briefly stated, various embodiments are directed to system, method, computer program product and application for providing a green platform for implementing a green share class that can integrate with a conventional funding and trading platforms. In implementations a green technology platform includes a service provider 112 configured to generate one or more “green” share classes 131 that can provide additional green share classes 131 to a new or pre-existing fund 130. The service provider 112 can receive, for each new green share class 131, payment of a fixed portion of the value of the assets under management in that share class, for example 10 basis points (“bps”), or 0.10 percent. The service fee comprises a small administration fee, for example 2 bps, with the bulk of the service fee set aside to be used as a “decarbonization fee,” for example, 8 bps (10 bps-2 bps). The service provider undertakes to execute transactions that spend up to the entirety of the decarbonization fee to provide its service of researching, purchasing, and retiring carbon offsets to match as best as possible, and on a continuous or periodic basis over time, the estimated carbon footprint of the fund's holdings over the course of a year, subject to any additional constraints on the carbon offsets as specified in that share class.

Periodically, for example each year, the service provider can update its decarbonization fee and its total service fee to reflect the then-current market conditions that ensure the fund can fully decarbonize the entire portfolio over the upcoming year under the conditions that the market prices and portfolio remain constant. If carbon offset prices turn out to be lower than the maximum budgeted for, or the carbon footprint of the portfolio turns out to be lower than anticipated, any excess decarbonization fee is returned to the fund. If, on the other hand, the carbon offset prices turn out to be higher than the maximum budgeted for, or the carbon footprint of the portfolio turns out to be higher than anticipated, the service provider purchases as much decarbonization as it can, reports the shortfall, and adjusts the decarbonization fee for the next year as needed. As an alternative, the service provider 112 can charge a variable cost with an optional cap equal to its actual costs for obtaining and retiring carbon offsets, plus the administration fee.

In at least one of the various embodiments, described are systems, methods and computer program products for providing a service provider platform comprising: a machine learning engine; an investor interface comprising a machine learning trained recommendation engine, the recommendation engine being configured to predict an optimal green share class allocation for an investment portfolio; and a carbon offset calculation tool application, the carbon offset calculation tool application being configured to at least:
for each day D in a period, obtain a plurality of security holdings of a fund as a list, the list comprising, for each security, a Security ID, Shares Held by Fund, Total Shares Outstanding of This Security, and Portion of Enterprise Market Cap (MC) Represented by the Security;
calculate a Portion of the Total Enterprise MC owned by the fund by a formula: the Shares Held by Fund divided by the Total Shares Outstanding of This Security times the Portion of Enterprise MC in the Security;
obtain an amount of carbon emissions for the enterprise associated with the security;
compute a portion of carbon emissions for which the fund is responsible by a Portion of the Total Enterprise MC owned by the fund times the amount of carbon emissions for the enterprise;
sum the portion of carbon emissions for which the fund is responsible for all the security holdings in the fund and divide the sum by a million;
compute the daily footprint as the portion that a given green share class is responsible for by multiplying the divided sum of the of the previous step by the fraction of fund assets held by the given green share class; and
calculate the average of the daily footprint for each day D of the period.

In an implementation, the investor interface is configured to at least: present and obtain answers from an investor for a plurality of questions; and output a green share class recommendation from the recommendation engine based on the answers. The plurality of questions can comprise: an absolute question type for a carbon offset project cost, a relative question type for a carbon offset preference between two carbon project offsets, and a conceptual question type for ranking carbon offset project types. The system can be configured to generate a training database using the answers to the questions from a plurality of investors; and train the recommendation engine on the training database using the machine learning engine.

In an implementation, the prediction engine can comprise a green share class recommendation engine selected from the group consisting of: a Random Forests trained prediction engine, a Gradient boosted trees trained prediction engine, a linear regression trained prediction engine, or a nearest neighbors trained prediction engine. In a technologically advantageous implementation, the green share class recommendation engine comprises a Random Forests trained prediction engine.

The prediction engine can be configured to output a green share class recommendation comprising: a share class allocation across green share classes and non-green share classes.

In an implementation, the system can comprise an interface operatively connected to one or more carbon registries, wherein the system is configured to track carbon credit transactions including carbon offset retirement. The carbon credit transactions can include transactions recorded on a distributed immutable ledger.

In an implementation, described is a method for a service provider platform comprising: a carbon offset calculation tool application. The method can comprise:
for each day D in a period, obtaining a plurality of security holdings of a fund as a list, the list comprising, for each security, a Security ID, Shares Held by Fund, Total Shares Outstanding of This Security, and Portion of Enterprise Market Cap (MC) Represented by this Security;
calculating a Portion of the Total Enterprise MC owned by the fund by a formula the Shares Held by Fund divided by the Total Shares Outstanding of This Security times the Portion of Enterprise MC in this Security;
obtaining an amount of carbon emissions for the enterprise associated with the security;
computing a portion of carbon emissions for which fund is responsible by a Portion of the Total Enterprise MC owned by the fund times the amount of carbon emissions for the enterprise;
summing the portion of carbon emissions for which the fund is responsible for all the security holdings in the fund and dividing the sum by a million;
computing the daily footprint as the portion that a given green share class is responsible for by multiplying the divided sum of the previous step by the fraction of fund assets held by the given green share class; and
calculating the average of the daily fund footprint for each day D of the period.

In an implementation, system can comprise an investor interface comprising a machine learning trained recommendation engine configured to predict an optimal green share class allocation for a security portfolio, and the method can comprise: presenting and obtaining answers from an investor via the investor interface for a plurality of questions; and outputting a green share class recommendation from the recommendation engine based on the answers. The method can further comprise presenting and obtaining the answers from the investor for the plurality of questions comprising:
an absolute question type for a carbon offset project cost,
a relative question type for a carbon offset preference between two carbon project offsets, and
a conceptual question type for ranking carbon offset project types.

In an implementation, the system can comprise a machine learning engine and the method can comprise:
generating a training database using the answers to the questions from a plurality of the investors; and
training the recommendation engine on the training database using the machine learning engine.

The method can comprise training the recommendation engine using a machine learning algorithm selected from the group consisting of: a Random Forests algorithm, a Gradient boosted trees algorithm, a linear regression algorithm, or a nearest neighbors algorithm. In an advantageous implementation, the method can include training the recommendation engine with the Random Forests algorithm.

In an implementation, the method can comprise outputting a green share class recommendation comprising: a share class allocation across green and classes and non-green share classes.

In an implementation, the system can comprise an interface operatively connected to one or more carbon registries, and the method can further comprise: tracking carbon credit transactions including carbon offset retirement.

The method can further comprise tracking the carbon credit transactions recorded on a distributed immutable ledger. In at least one of the various embodiments, the application can comprise a data management tool configured to log transactions on the distributed immutable ledger; and a transaction tool configured to transact on the distributed immutable ledger, wherein the distributed immutable ledger is configured to encrypt blocks of ledger data by encoding each ledger block with a hash of a prior block.

In at least one of the various embodiments, the distributed immutable ledger can be a Blockchain.

In at least one of the various embodiments, the distributed immutable ledger can be selected from a Bitcoin Blockchain, an Ethereum Blockchain, a Ripple distributed immutable ledger, a Hyperledger distributed immutable ledger, a Stellar distributed immutable ledger, and an IBM Blockchain.

In at least one of the various embodiments, a finance component can comprise the scoring tool being configured to generate a score.

In at least one of the various embodiments, a method for providing a trusted network comprises, in at least one computer including one or more processors and memory operatively coupled to the computer system, the method comprising the actions and processes described for the system and system components thereof herein.

In at least one of the various embodiments, a computer program product comprising computer readable storage medium encoded with instructions that, when executed by at least one processor in a computer system that comprises one or more processors and memory operatively coupled to the computer system causes the computer to perform the actions and processes and system components described for the system and methods herein.

### Illustrative Operating Environment

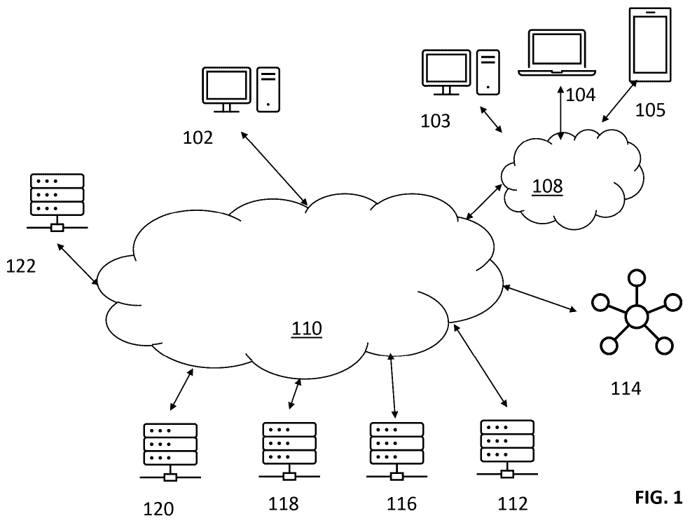

FIG. 1 shows components of one embodiment of an environment in which embodiments of the innovations described herein may be practiced. Not all of the components may be required to practice the innovations, and variations in the arrangement and type of the components may be made without departing from the spirit or scope of the innovations. As shown, system 100 of FIG. 1 includes local area networks (LANs)/wide area networks (WANs)-(network) 110, wireless network 108, client computers 102-105, Service Provider Platform Server Computer 112, Financial Service Entity Server 116, Content Data Server 118, Registry Server 120, Exchange Server 122, and Distributed Immutable Ledger Server Computers 114.

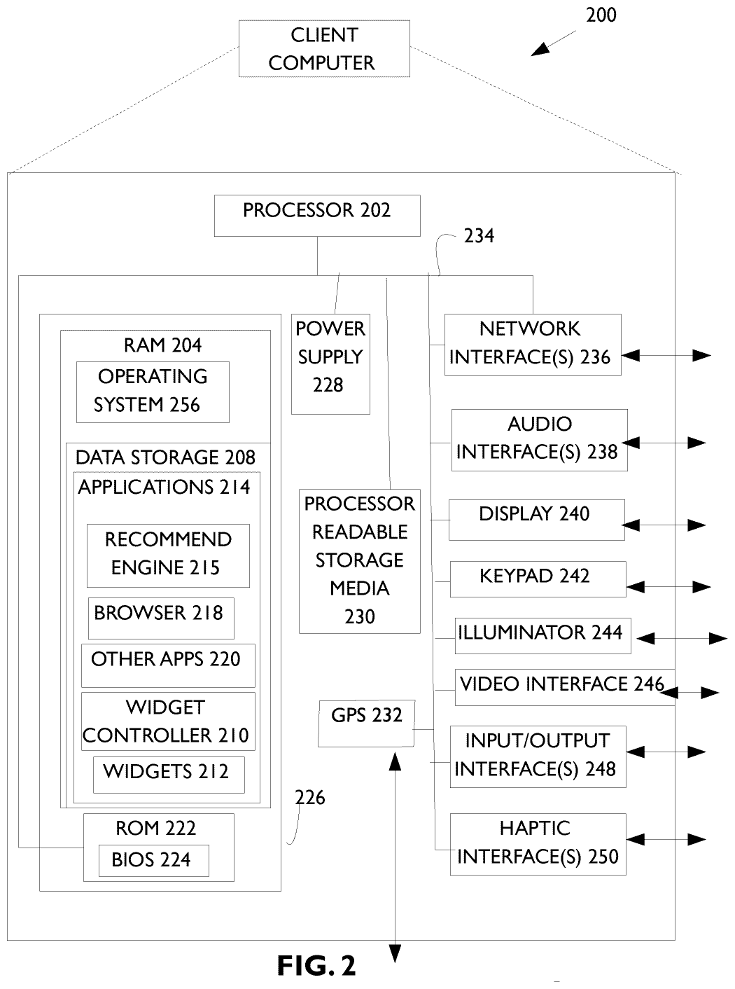

At least one embodiment of client computers configured as client computers 102-105 is described in more detail below in conjunction with FIG. 2. In one embodiment, at least some of client computers 102-105 may operate over a wired and/or wireless network, such as networks 110 and/or 108. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, an accounting server, a production server, an inventory server, or the like. However, client computers 102-105 are not constrained to these services and may also be employed, for example, as an end-user computing node, in other embodiments. It should be recognized that more or less client computers may be included within a system such as described herein, and embodiments are therefore not constrained by the number or type of client computers employed.

Computers that may operate as client computer 102-105 may include computers that typically connect using a wired or wireless communications medium such as personal computers, multiprocessor systems, microprocessor-based or programmable electronic devices, network PCs 102, 103, or the like. In some embodiments, client computers 102-105 may include virtually any portable personal computer capable of connecting to another computing device and receiving information such as, laptop computer 104 and smart mobile telephone 105, and tablet computers, and the like. However, portable computers are not so limited and may also include other portable devices such as cellular telephones, display pagers, radio frequency (RF) devices, infrared (IR) devices, Personal Digital Assistants (PDAs), handheld computers, wearable computers, integrated devices combining one or more of the preceding devices, and the like. As such, client computers 102-105 typically range widely in terms of capabilities and features. Moreover, client computers 102-105 may access various computing applications, including a browser, or other web-based application.

A web-enabled client computer may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), extensible Markup Language (XML), and the like, to display and send a message. In one embodiment, a user of the client computer may employ the browser application to perform various activities over a network (online). However, another application may also be used to perform various online activities.

Client computers 102-105 may also include at least one other client application that is configured to receive and/or send content between another computer. The client application may include a capability to send and/or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), or other device identifier. Such information may be provided in a network packet, or the like, sent between other client computers, Platform Server Computer 112, Distributed Immutable Ledger Database Server Computer 114, or other computers.

Client computers 102-105 may further be configured to include a client application that enables an end-user to log into an end-user account that may be managed by another computer, such a Server Computer 112, Distributed Immutable Ledger Computers 114, or the like. Such end-user account, in one non-limiting example, may be configured to enable the end-user to manage one or more online activities, including in one non-limiting example, search activities, social networking activities, browse various websites, communicate with other users, or the like. However, participation in such online activities may also be performed without logging into the end-user account.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile devices, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, and the like.

Network 110 is configured to couple network computers with other computers and/or computing devices, including, Platform Server Computers 112, Distributed Immutable Ledger Server Computers 114, client computer 102, and client computers 103-105 through wireless network 108. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP). In essence, network 110 includes any communication method by which information may travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

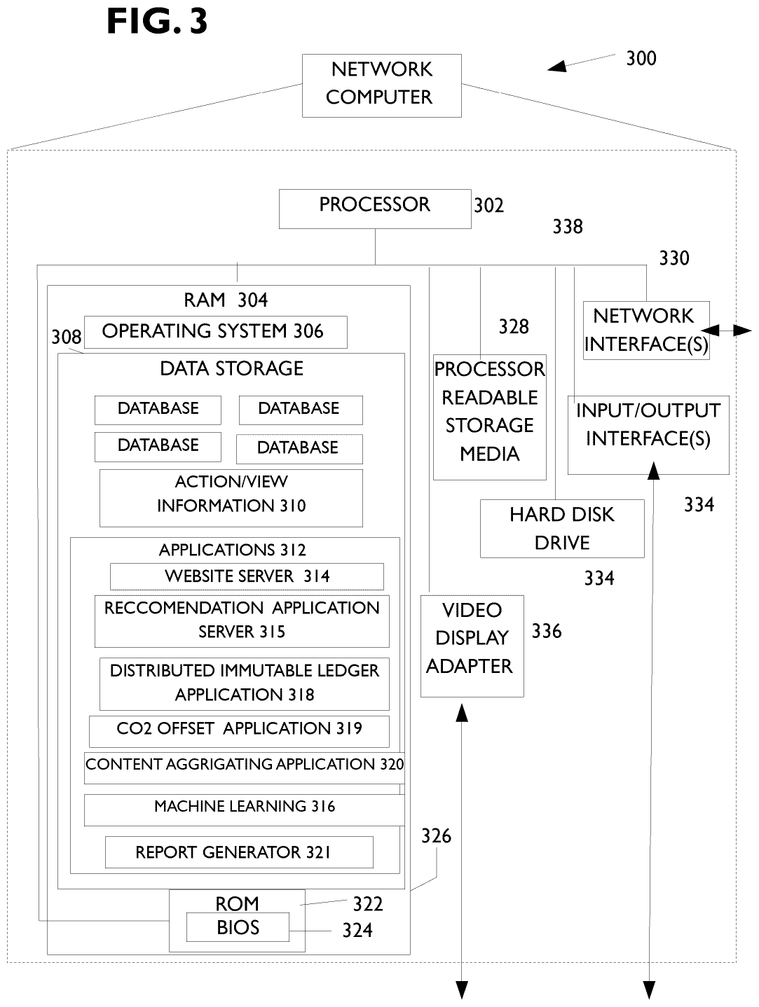

One embodiment of Service Provider Platform Server Computer 112 is described in more detail below in conjunction with FIG. 3. Briefly, however, Platform Server Computer 112 includes virtually any network computer capable of supporting Applications and Application Program Interfaces therefor as well as providing network and scoring tools as describe herein. Computers that may be arranged to operate as Platform Server Computer 112 include various network computers, including, but not limited to personal computers, desktop computers, multiprocessor systems, microprocessor-based or programmable consumer electronics, network PCs, server computers, network appliances, and the like.

Although FIG. 1 illustrates Platform Server Computer 112 as a single computer, the invention is not so limited. For example, one or more functions of the Platform Server Computer 112 may be distributed across one or more distinct network computers. Moreover, Platform Server Computer 112 is not limited to a particular configuration. Thus, in one embodiment, Platform Server Computer 112 may contain a plurality of network computers. In another embodiment, Platform Server Computer 112 may contain a plurality of network computers that operate using a master/slave approach, where one of the plurality of network computers of Platform Server Computer 112 is operative to manage and/or otherwise coordinate operations of the other network computers. In other embodiments, the Platform Server Computer 112 may operate as a plurality of network computers arranged in a cluster architecture, a peer-to-peer architecture, and/or even within a cloud architecture. Other configurations, and architectures are also envisaged.

Distributed Immutable Ledger Server Computers 114 includes virtually any network computer capable of sharing a ledger across a network and configured as a distributed immutable ledger node, including client computers and network computers as described herein. Distributed Immutable Ledger Server Computers 114 are distributed across one or more distinct network computers in a peer-to-peer architecture. Other configurations, and architectures are also envisaged.

In an embodiment, the network will be private to the parties concerned, permissioned so only authorized parties are allowed to join, and can be secure using cryptographic technology to ensure that participants only see what they are allowed to see. The shared ledger is replicated and distributed across the networked computers. Transactions are immutable (unchangeable) and final. Computers that may be arranged to operate as Distributed Immutable Ledger Server Computers 114 include various network computers, including, but not limited to personal computers, desktop computers, multiprocessor systems, microprocessor-based or programmable consumer electronics, network PCs, server computers, network appliances, and the like.

The distributed immutable ledger is a shared ledger that can be either public or private for recording the history of electronic business transactions that take place in a peer-to-peer (P2P) business network. A blockchain is an example of a distributed immutable transaction ledger. A blockchain network is a decentralized system for the exchange of assets and recording of transactions. A blockchain network may use “Proof of Work,” or another consensus mechanism, as a basis of trust, accountability, and transparency, instead of relying on a third-party mediator financial institution or actor. In an embodiment, each permissioned node of the network has a replicated copy of the ledger, and all events on the ledger are synched across all nodes and immutable, resulting in full transparency for all node members.

A transaction system for a distributed immutable ledger can include digital signatures, cryptographic hashes, a timestamp server, and a decentralized consensus protocol that member nodes use to agree on ledger content. In a public ledger, integrity, privacy, and security are engineered in. For example, a blockchain ledger is comprised of unchangeable, digitally recorded data in packages called blocks. These digitally recorded “blocks” of data are stored in a linear chain. Each block in the chain contains data (e.g. for a cryptocurrency transaction, or a smart contract executable), that is cryptographically hashed. The blocks of hashed data draw upon the previous-block (which came before it) in the chain, ensuring all data in the overall “blockchain” has not been tampered with and remains unchanged. A distributed immutable ledger peer-to-peer network is resilient and robust thanks to its decentralized topology architecture. As member nodes join or leave the network dynamically, messages are exchanged between the network participants on a best-effort broadcast basis.

A number of distributed technological platforms for distributed immutable ledgers and consensus can be employed. Exemplary distributed immutable ledger platforms include Bitcoin, Ethereum, Ripple, Hyperledger, Stellar, IBM Blockchain, and other enterprise solutions.

Ethereum, for example, is a programmable distributed immutable ledger blockchain. Ethereum allows users to create their own operations of any complexity. In this way, the Ethereal distributed immutable ledger platform can support many different types of decentralized blockchain applications, including but not limited to cryptocurrencies and smart contracts. Ethereum comprises a suite of protocols that define a platform for decentralized applications. The platform comprises an Ethereum Virtual Machine (“EVM”), which can execute code of arbitrary algorithmic complexity. Developers can create applications that run on the EVM using friendly programming languages modelled on existing languages, for example, JavaScript and Python.

Ethereum also includes a peer-to-peer network protocol. The Ethereum distributed immutable ledger database is maintained and updated by many nodes connected to the network. Each and every node of the network runs the EVM and executes the same instructions. This massive parallelization of computing across the entire Ethereum network maintain consensus and immutability for the blockchain transactions and events on the ledger. Every Ethereum node runs the EVM in order to maintain consensus across the blockchain. Decentralized consensus gives Ethereum high fault tolerance, ensures zero downtime, and makes data stored on the blockchain forever unchangeable and censorship-resistant.

Ethereum's basic unit is the account. The Ethereum blockchain tracks the state of every account, and all state transitions on the Ethereum blockchain are transfers of value and information between accounts. There are two types of accounts: Externally Owned Accounts (EOAs), which are controlled by private keys and Contract Accounts C, which are controlled by their contract code and can only be “activated” by an EOA. For most users, the basic difference between these is that human users control EOAs-because they can control the private keys which give control over an EOA. Contract accounts, on the other hand, are governed by their internal code. If they are “controlled” by a human user, it is because they are programmed to be controlled by an EOA with a certain address, which is in turn controlled by whoever holds the private keys that control that EOA. The term “smart contracts” refers to code in a Contract Account-programs that execute when a transaction is sent to that account. Users can create new contracts by deploying code to the blockchain.

Contract accounts only perform an operation when instructed to do so by an EOA. So it is not possible for a Contract account to be performing native operations like random number generation or API calls—it can do these things only if prompted by an EOA. This is because the platform requires nodes to be able to agree on the outcome of computation, which requires a guarantee of strictly deterministic execution.

Nodes can download a distributed immutable ledger application that provides a gateway to decentralized applications on the Ethereum blockchain. The application is configured to hold and secure ether and other crypto-assets built on Ethereum, as well as to code, deploy and employ, inter alia, self-executing smart contracts.

On the distributed immutable ledger, anyone can set up a node that replicates the necessary data for all nodes to reach an agreement and be compensated by users. This allows user data to remain private and applications to be decentralized. The distributed immutable ledger also enables developers create, inter alia, fully automated applications that, for example, store registries of debts or promises, send messages, move funds in accordance with predetermined instructions, including encoding those given long in the past (e.g., like a will or a futures contract), all without a middle man or counterparty risk. As will be appreciated, the Ethereum blockchain is an example of distributed immutable ledger architecture and platform, and one or more of the embodiments can be configured to run on any distributed immutable ledger platform, including those referenced herein.

### Illustrative Client Computer

FIG. 2 shows one embodiment of client computer 200 that may be included in a system implementing embodiments of the invention. client computer 200 may include many more or less components than those shown in FIG. 2. However, the components shown are sufficient to disclose an illustrative embodiment for practicing the present invention. client computer 200 may represent, for example, one embodiment of at least one of client computers 102-105 of FIG. 1.

As shown in the figure, client computer 200 includes a processor 202 in communication with a mass memory 226 via a bus 234. In some embodiments, processor 202 may include one or more central processing units (CPU). client computer 200 also includes a power supply 228, one or more network interfaces 236, an audio interface 238, a display 240, a keypad 242, an illuminator 244, a video interface 246, an input/output interface 248, a haptic interface 250, and a global positioning system (GPS) receiver 232.

Power supply 228 provides power to client computer 200. A rechargeable or non-rechargeable battery may be used to provide power. The power may also be provided by an external power source, such as an alternating current (AC) adapter or a powered docking cradle that supplements and/or recharges a battery.

Client computer 200 may optionally communicate with a base station (not shown), or directly with another computer. Network interface 236 includes circuitry for coupling client computer 200 to one or more networks, and is constructed for use with one or more communication protocols and technologies including, but not limited to, GSM, CDMA, TDMA, GPRS, EDGE, WCDMA, HSDPA, LTE, user datagram protocol (UDP), transmission control protocol/Internet protocol (TCP/IP), short message service (SMS), WAP, ultra wide band (UWB), IEEE 802.16 Worldwide Interoperability for Microwave Access (WiMax), session initiated protocol/real-time transport protocol (SIP/RTP), or any of a variety of other wireless communication protocols. Network interface 236 is sometimes known as a transceiver, transceiving device, or network interface card (NIC).

Audio interface 238 is arranged to produce and receive audio signals such as the sound of a human voice. For example, audio interface 238 may be coupled to a speaker and microphone (not shown) to enable telecommunication with others and/or generate an audio acknowledgement for some action.

Display 240 may be a liquid crystal display (LCD), gas plasma, light emitting diode (LED), organic LED, or any other type of display used with a computer. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images.

Illuminator 244 may provide a status indication and/or provide light. Illuminator 244 may remain active for specific periods of time or in response to events. For example, when illuminator 244 is active, it may backlight the buttons on keypad 242 and stay on while the client computer is powered. Also, illuminator 244 may backlight these buttons in various patterns when particular actions are performed, such as dialing another client computer. Illuminator 244 may also cause light sources positioned within a transparent or translucent case of the client computer to illuminate in response to actions.

Video interface 246 is arranged to capture video images, such as a still photo, a video segment, an infrared video, or the like. For example, video interface 246 may be coupled to a digital video camera, a web-camera, or the like. Video interface 246 may comprise a lens, an image sensor, and other electronics. Image sensors may include a complementary metal-oxide-semiconductor (CMOS) integrated circuit, charge-coupled device (CCD), or any other integrated circuit for sensing light.

Client computer 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like.

Haptic interface 250 is arranged to provide tactile feedback to a user of the client computer. For example, the haptic interface 250 may be employed to vibrate client computer 200 in a particular way when another user of a computing computer is calling. In some embodiments, haptic interface 250 may be optional.

Client computer 200 may also include GPS transceiver 232 to determine the physical coordinates of client computer 200 on the surface of the Earth. GPS transceiver 232, in some embodiments, may be optional. GPS transceiver 232 typically outputs a location as latitude and longitude values. However, GPS transceiver 232 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 200 on the surface of the Earth. It is understood that under different conditions, GPS transceiver 232 can determine a physical location within millimeters for client computer 200; and in other cases, the determined physical location may be less precise, such as within a meter or significantly greater distances. In one embodiment, however, client computer 200 may through other components, provide other information that may be employed to determine a physical location of the computer, including for example, a Media Access Control (MAC) address, IP address, or the like.

Mass memory 226 includes a Random Access Memory (RAM) 204, a Read-only Memory (ROM) 222, and other storage means. Mass memory 226 illustrates an example of computer readable storage media (devices) for storage of information such as computer readable instructions, data structures, program modules or other data. Mass memory 226 stores a basic input/output system (BIOS) 224 for controlling low-level operation of client computer 200. The mass memory also stores an operating system 206 for controlling the operation of client computer 200. It will be appreciated that this component may include a general-purpose operating system such as a version of UNIX, or LINUX™, or a specialized client communication operating system such as Microsoft Corporation's Windows Mobile™, Apple Corporation's iOS™, Google Corporation's Android™ or the Symbian® operating system. The operating system may include, or interface with a Java virtual machine module that enables control of hardware components and/or operating system operations via Java application programs.

Mass memory 226 further includes one or more data storage 208, which can be utilized by client computer 200 to store, among other things, applications 214 and/or other data. For example, data storage 208 may also be employed to store information that describes various capabilities of client computer 200. The information may then be provided to another computer based on any of a variety of events, including being sent as part of a header during a communication, sent upon request, or the like. Data storage 208 may also be employed to store social networking information including address books, buddy lists, aliases, user profile information, or the like. Further, data storage 208 may also store message, we page content, or any of a variety of user generated content. At least a portion of the information may also be stored on another component of client computer 200, including, but not limited to processor readable storage media 230, a disk drive or other computer readable storage devices (not shown) within client computer 200.

Processor readable storage media 230 may include volatile, nonvolatile, removable, and non-removable media implemented in any method or technology for storage of information, such as computer- or processor-readable instructions, data structures, program modules, or other data. Examples of computer readable storage media include RAM, ROM, Electrically Erasable Programmable Read-only Memory (EEPROM), flash memory or other memory technology, Compact Disc Read-only Memory (CD-ROM), digital versatile disks (DVD) or other optical storage, magnetic cassettes, magnetic tape, magnetic disk storage or other magnetic storage devices, or any other physical medium which can be used to store the desired information and which can be accessed by a computer. Processor readable storage media 230 may also be referred to herein as computer readable storage media and/or computer readable storage device.

Applications 214 may include computer executable instructions which, when executed by client computer 200, transmit, receive, and/or otherwise process network data. Network data may include, but is not limited to, messages (e.g. SMS, Multimedia Message Service (MMS), instant message (IM), email, and/or other messages), audio, video, and enable telecommunication with another user of another client computer. Applications 214 may include, for example, browser 218, and other applications 220. Other applications 220 may include, but are not limited to, calendars, search programs, map programs, email clients, IM applications, SMS applications, voice over Internet Protocol (VOIP) applications, contact managers, task managers, transcoders, database programs, word processing programs, security applications, spreadsheet programs, games, search programs, and so forth.

Browser 218 may include virtually any application configured to receive and display graphics, text, multimedia, messages, and the like, employing virtually any web based language. In one embodiment, the browser application is enabled to employ HDML, WML, WMLScript, JavaScript, SGML, HTML, XML, and the like, to display and send a message. However, any of a variety of other web-based programming languages may be employed. In one embodiment, browser 218 may enable a user of client computer 200 to communicate with another network computer, such as Platform Server Computer 112 and/or Distributed Immutable Ledger Server Computers 114 of FIG. 1.

Applications 214 may also include Widget Controller 210 and one or more Widgets 212. Widgets 212 may be collections of content provided to the client computer by Platform Server Computer 112. Widget Controller 210 may be a program that may be provided to the client computer by Platform Server Computer 112. Widget Controller 210 and Widgets 212 may run as native client computer applications or they may run in Browser 218 as web browser based applications. Also, Widget Controller 210 and Widgets 212 may be arranged to run as native applications or web browser applications, or combination thereof. In at least one of the various embodiments, Recommendation Engine Application 215 and its components can be configured as Widgets.

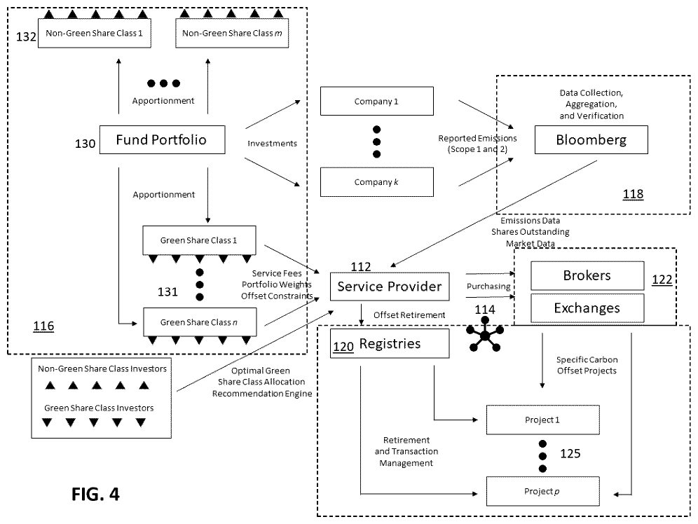

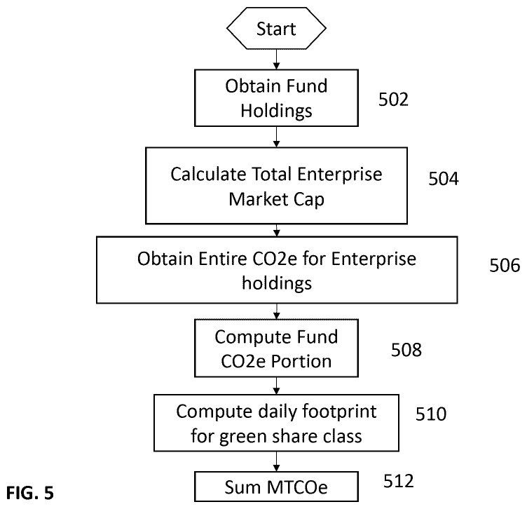

Applications 214 can also include a Recommendation Engine Application 215. Recommendation Engine Application 215 can be a program that may be provided to the client computer by Platform Server Computer 112 and supported by Recommendation Engine Application Server of Platform Server Computer 112. Recommendation Engine Application 215 can run as a native client computer application or can run in Browser 218 as a web browser based application. Recommendation Engine Application 215 can also be arranged to run as a combination of a native application and a web browser application. Recommendation Engine Application 215 and its tools and modules may employ processes, or parts of processes, similar to those described in conjunction with FIG. 4-5, to perform at least some of its actions.

### Illustrative Network Computer

FIG. 3 shows one embodiment of a network computer 300, according to one embodiment of the invention. Network computer 300 may include many more or less components than those shown. The components shown, however, are sufficient to disclose an illustrative embodiment for practicing the invention. Network computer 300 may be configured to operate as a server, client, peer, a host, or any other computer. Network computer 300 may represent, for example Platform Server Computer 112.

Network computer 300 includes processor 302, processor readable storage media 328, network interface unit 330, an input/output interface 332, hard disk drive 334, video display adapter 336, and memory 326, all in communication with each other via bus 338. In some embodiments, processor 302 may include one or more central processing units.

As illustrated in FIG. 3, network computer 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (NIC).

Network computer 300 also comprises input/output interface 332 for communicating with external devices, such as a keyboard, or other input or output devices not shown in FIG. 3. Input/output interface 332 can utilize one or more communication technologies, such as USB, infrared, Bluetooth™, or the like.

Memory 326 generally includes RAM 304, ROM 322 and one or more permanent mass storage devices, such as hard disk drive 334, tape drive, optical drive, and/or floppy disk drive. Memory 326 stores operating system 306 for controlling the operation of network computer 300. Any general-purpose operating system may be employed. Basic input/output system (BIOS) 324 is also provided for controlling the low-level operation of network computer 300.

Although illustrated separately, memory 326 may include processor readable storage media 328. Processor readable storage media 328 may be referred to and/or include computer readable media, computer readable storage media, and/or processor readable storage device. Processor readable storage media 328 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computer.

Memory 326 further includes one or more data storage 308, which can be utilized by network computer 300 to store, among other things, applications 314 and/or other data such as content 310. For example, data storage 308 may also be employed to store information that describes various capabilities of network computer 300. The information may then be provided to another computer based on any of a variety of events, including being sent as part of a header during a communication, sent upon request, or the like. Data storage 308 may also be employed to store messages, web page content, or the like. At least a portion of the information may also be stored on another component of network computer 300, including, but not limited to processor readable storage media 328, hard disk drive 334, or other computer readable storage medias (not shown) within client computer 300.

Data storage 308 may include a database, text, spreadsheet, folder, file, or the like, that may be configured to maintain and store user account identifiers, user profiles, email addresses, IM addresses, and/or other network addresses; or the like.

In at least one of the various embodiments, data storage 308 may include a content and verification database 310, which can contain information from content services (e.g. Financial News sources), including data obtained from a verification database.

Data storage 308 may further include program code, data, algorithms, and the like, for use by a processor, such as processor 302 to execute and perform actions. In one embodiment, at least some of data store 308 might also be stored on another component of network computer 300, including, but not limited to processor-readable storage media 328, hard disk drive 334, or the like.

Applications 312 may include computer executable instructions, which may be loaded into mass memory and run on operating system 306. Examples of application programs may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth. Applications 312 may also include website server 314, Recommendation Engine Application Server 315, Distributed Immutable Ledger Server 318, Carbon Offset Calculation Application 319, Machine Learning Engine 316, and/or Content Aggregating Application 321.

Website server 314 may represent any of a variety of information and services that are configured to provide content, including messages, over a network to another computer. Thus, website server 314 can include, for example, a web server, a File Transfer Protocol (FTP) server, a database server, a content server, or the like. Website server 314 may provide the content including messages over the network using any of a variety of formats including, but not limited to WAP, HDML, WML, SGML, HTML, XML, Compact HTML (cHTML), Extensible HTML (xHTML), or the like.

Recommendation Engine Application Server 315 may be configured to support and provide content to client Recommendation Engine Application 215 and for Application tools and modules as described herein. Recommendation Application Server 315 can be hosted on Platform Server Computer 112 of FIG. 1, or the like. Recommendation Application Server 315 may employ processes, or parts of processes, similar to those described in conjunction with FIGS. 4-5, to perform at least some of its actions. In at least one of the various embodiments, Report Generator 321 may be operative on Platform Server Computer 114 of FIG. 1.

A Machine Learning Engine 316 can be configured to train on investor information and provide green share recommendations. Machine intelligence engine 316 can comprise Artificial Intelligence (AI) machine learning (ML)-based processing and classification. AI machine learning classification can be based on any of a number of known machine learning algorithms, for example, neural nets (including fully connected, convolutional and recurrent neural nets, or neural nets created as a combination of these blocks), decision trees, conditional random fields (CRFs), propositional rule learner, logistic regression, and the like). In at least one embodiment, ML-based processing engine 316 is implemented as a Random Forests trained prediction engine, a Gradient boosted trees trained prediction engine, a linear regression trained prediction engine, or a nearest neighbors trained prediction engine. AI machine intelligence engine 316 can be separated into inference and training (classifier building) components, which can be employed at different points of time. A Machine Learning Engine 316 may employ processes, or parts of processes, similar to those described in conjunction with FIGS. 4-5, to perform at least some of its actions. In at least one of the various embodiments, Report Generator 321 may be operative on Platform Server Computer 114 of FIG. 1

A Distributed Immutable Ledger Application 318 can be configured to provide a gateway to decentralized applications on the Distributed Immutable Ledger platform and act as a node on the Distributed Immutable Ledger platform. The Distributed Immutable Ledger Application 318 application can be configured to hold and secure crypto-assets built on the platform, as well as to code, deploy and employ, inter alia, self-executing smart contracts.

The Distributed Immutable Ledger Application 217 can include a data management tool configured to record application usage and transaction data to the distributed immutable ledger 114 associated with the client that is also registered to the application. The data management tool can be configured to communicate with the Distributed Immutable Ledger Computer Servers 114 to control, share, accept, and synchronize data. In an embodiment, the data management tool 256 can include a logging tool configured to log and store data in one or more databases, including transactions recorded on the distributed immutable ledger 214. The logging tool can also be configured to log transactions on the distributed immutable ledger 114. In at least one of the various embodiments, Platform Sever Computer 112 can be permissioned to a Distributed Immutable Ledger Computer Server 114 node for the distributed immutable ledger of the client or server entity that is also registered to the Distributed Immutable Ledger Application 217.

The Distributed Immutable Ledger Application 114 can include a transaction interface tool for entering into transactions that are recorded on the distributed immutable ledger, including transactions such as smart contracts and/or cryptocurrency transactions.

Carbon Offset Calculation Tool Application 319 may be arranged and configured to calculate carbon offsets for green fund shares. In at least one of the various embodiments, Carbon Offset Calculation Tool Application 318 can be operative on Platform Server Computer 112 of FIG. 1 or the like. Carbon Offset Calculation Tool Application 318 may employ processes, or parts of processes, similar to those described in conjunction with FIGS. 4-5, to perform at least some of its actions.

Content Aggregating Application 320 may be arranged and configured to obtain information from Content Server 118 for fund components for data driven funding analysis. Content Aggregating Application 320 may be operative on Platform Server Computer 112 of FIG. 1. Finance Component Application 320 may employ processes, or parts of processes, similar to those described in conjunction with FIGS. 4-5 to perform at least some of its actions . . .

### Illustrative Logical System Architecture and Generalized Operation

The operation of certain aspects of the invention will now be described with respect to FIGS. 4-5. In at least one of various embodiments, for processes described with respect to FIGS. 4-5, these processes or portions of these processes may be implemented by and/or executed on a plurality of network computers, such as client computer 200 of FIG. 2 and network computer 300 of FIG. 3. However, embodiments are not so limited, and various combinations of network computers, client computers, virtual machines, or the like may be utilized. Further, in at least one of the various embodiments, the processes described in conjunction with FIGS. 4-5 may be operative in system with logical architectures such as those described in conjunction with FIGS. 4-5.

A logical architecture is described with respect to FIG. 4. In an implementation, the system is configured to employ a process for calculating a portfolio carbon footprint. In an implementation the system executes a function that represents a daily calculation of the carbon footprint of a fund portfolio. The system computes the daily footprint by multiplying a portion of emissions that a given green share class of the fund is responsible for by a fraction of all the security holdings of the fund held by the given green share class. This calculation uses the mandatorily reported values of each publicly listed company's daily Emissions Scopes 1 and 2, following the Greenhouse Gas Protocol, to determine the proportionate amount under the fund's responsibility of that total as a ratio of the amount of shares of the firm owned by the fund 130 green share class 131 divided by the firm's total shares outstanding. The sum of these carbon exposures across all holdings determines the fund's carbon footprint for that day, as measured in Metric Tons of Carbon Dioxide or Equivalent (“MTCO2e”). These numbers can have a reporting lag.

Next, the service provider platform server 112 accesses one or more carbon registries 120 to source available carbon offsets in the market that best match the environmental requirements of the share class, while also costing as little as possible, to try to ensure sufficient cash reserves for tomorrow's carbon offsets purchases. This part of the process involves communicating with brokers, retailers, and exchanges, for example at exchange server 122, to source reliable projects on established registries 120. If the green share class 131 under consideration imposes additional constraints on the allowable types of carbon offsets, those constraints can be monitored and fulfilled in this step as well.

As soon as the service provider platform server 112 purchases carbon offsets, the service provider platform server 112 instantly retires them giving the share class 131 immediate carbon reduction credit. This ensures that the carbon offsets have no asset-like characteristic and there is no exposure to changes in market prices. It also ensures there is never a sale of a carbon offset, and only purchases of carbon offsets are executed. Retiring a carbon offset alerts the registry 120 that it has been used and cannot be sold or transferred anymore, and hence is no longer an asset.

However, a technical implementation of a daily transactional system can prove impractical. For example, market liquidity, time constraints, piecemeal interactions in carbon offsets can result in losses and performance lags. Accordingly, in an implementation, the system can be configured with algorithms that execute a function representing a daily calculation that can be executed on a quarterly basis. For example, every quarter, the service provider server 112 is configured to compute a total of the daily carbon footprints of the fund holdings over the previous quarter to obtain the quarterly carbon footprint. The system can then be configured to source, purchases, and instantly retire the requisite carbon offsets from the market at the best available price among those offsets meeting the conditions of the share class.

In an implementation, described is function for calculating an average fund footprint. It can be implemented for entire fund holdings, across all share classes.

FIG. 5 illustrates a flowchart for process 500 for calculating an average fund footprint. It can be implemented for entire fund holdings, across all share classes

After a start block, at block 502, in at least one of the various embodiments, for each day D in a period (e.g.: one quarter) the system is configured to obtain the holdings of the fund as a list: Security ID, Shares Held by Fund, Total Shares Outstanding of This Security, and Portion of Enterprise Market Cap Represented by this Security. The Security ID is a unique primary key, meaning, there are no duplicate Security ID rows in this list.

As an example, a fund holds 1 million shares of Google C class shares (ticker: GOOG) and 250,000 of these shares are held by green share class 131. The total amount of C-class shares is 6,086,000,000. The portion of the enterprise market cap that is represented by the C class shares is: 6,086,000,000/(5,973,000,000+884,000,000+6,086,000,000)=47.02%. Accordingly, the line for this example reads:
GOOG US, 1000000, 6086000000, .470215563

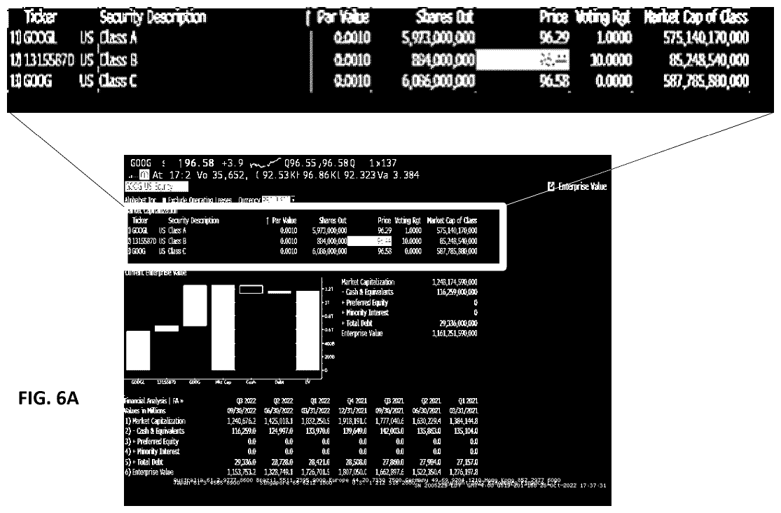

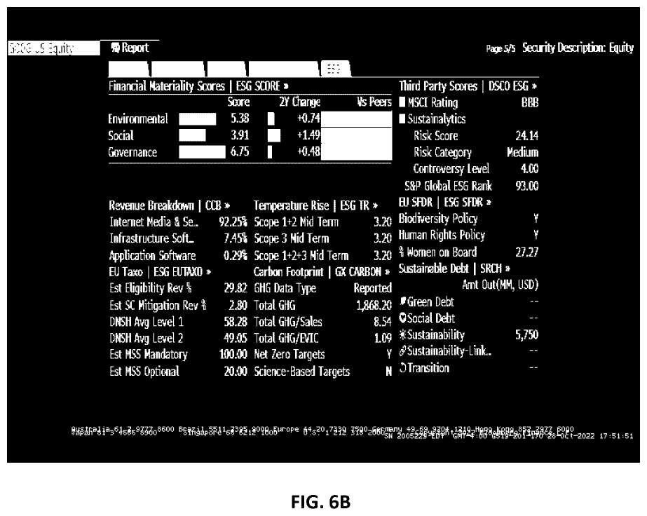

FIGS. 6A-6B show interface screenshots for a trading GUI, which shows where the exemplary (here public) data, for example provided by a content server 118, comes from.

At block 504, for each holding, the system is configured to calculate the portion of the total enterprise market cap owned by the fund: The formula is Shares Held by Fund/Total Shares Outstanding of This Security * Portfolio of Enterprise MC in this Security

For the example above, the total enterprise market cap owned by the fund is
1,000,000/6,086,000,000 * 0.470215563=0.00007726184.
   In other words, the fund owns 0.77 bps of the company (1 bp=1% of 1%).

At block 506, for each holding, the system is configured to look up the amount of carbon emissions for the entire enterprise: For the example, as shown in FIG. 6B, according to and Environmental Social Governance (ESG) screen for the GUI, the total carbon emissions for the enterprise is 1,868.20 per year (in thousands of CO2-equivalent metric tonnes). This is the sum of Scope 1 and 2 emissions, as reported or as estimated by a trading and financial news platform (e.g.: Bloomberg), depending on what they show in the screen.

At block 508, the system is configured to compute the portion of carbon emissions for which the fund is responsible. This is the portion of the enterprise owned by the fund times the amount of carbon emissions. For the example, as computed or as listed above, this is

0.00007726184 * 1,868,200,000=144,340 metric tonnes per year or 144,340/365 days per year=395.5 metric tonnes per day

At block 508, to obtain the total MTCO2e of the fund for this day, the system is configured to sum up the portion for which the fund is responsible for all the securities and divide the sum by a million. The carbon emissions that the green share class is responsible for is the fraction of the fund's Google C class shares held by the fund's green share class times the portion of carbon emissions the fund is responsible for. 395.5 metrics tonnes per day * 250,000/1,000,000=98.86 metric tonnes per day. At block 510, the system then computes the daily footprint by multiplying the total MTCO2e by the fraction of fund assets held by the given green share class.

At block 512, to obtain the amount that needs to be offset with carbon offsets, the system can calculate the average of the daily fund footprints for each day D of the period (e.g.: the quarter).

In an implementation, described is a database, for example a distributed immutable ledger (blockchain) 114 technology, configured to accurately track carbon credits purchased, owned, and extinguished with date and valid certification that the credit has not been double counted.

In an implementation, described is system for predicting with a determined degree of certainty that a share class's attributable carbon footprint has been offset in a specific time period.

In an implementation, described is a system for accurately predicting an investor's optimal portfolio, including both an optimal percent of carbon-neutrality and optimal credit type (technology vs. nature etc.). With multiple share classes, investors may need computational help choosing their optimal mix of green and non-green investments.

The service provider system 112 can be configured to perform of market-related services for the fund and on behalf of the fund. The system can include a recommendation engine 315 configured to offer an additional, specific information service for individual investors and prospective investors. Individual investors face two choices in calibrating a green fund allocation: (a) how much of the allocation to the fund should be in non-green vs. green share classes? and (b) how should the green portion of their fund be allocated across the potentially multiple green share classes of the fund? For funds with only one green share class alternative, the second choice is integrated into the first, but does not disappear, because the project constraints of the single green share class may not perfectly match the preferences of the investor. For example, if the green share class includes additional social benefits within the carbon offset constraints, but the investor does not value such additional benefits in the context of carbon offsets, the investor may optimally prefer to invest less than otherwise; and vice versa if the preferences and constraints are swapped, the investor may prefer to invest more than otherwise, effectively spending more on carbon offsets than they otherwise would.

In an implementation, an optimal green share class recommendation engine 315 can be configured to inform investors about allocation strategies for both of these choices. The optimal green share class recommendation engine 315 can be configured to provide information based on three factors: (a) the investor's own investments in both the fund under consideration as well as in other funds, (b) the investor's preferences as revealed through an information collection system and interface, described further below, and (c) the answers of other investors to the first two questions using the system, including their ultimate proportion and allocation of green investment in the fund under consideration.

Investor green preferences can be revealed through an information collection system as follows. The investor logs in to a platform hosting optimal green share class recommendation engine 315, for example, on a website server 314 and/or application server 315 run by the service provider 112 or a recommendation engine application 215. The investor is prompted with a variety of three types of questions: absolute, relative, and conceptual.

Each absolute question presents details about a particular carbon offset project and asks the investor how much they would be willing to pay for it, or to give a range starting from a floor minimum they would pay for any carbon offset project to the most they would ever pay for any carbon offset project, with all prices reflected on a per-MTCO2e basis.

Each relative question presents details about two particular carbon offset projects side-by-side and asks the investor which of the two they would prefer, or neither.

Each conceptional question presents details about types of carbon offset projects, for example such as nature-based vs. technology based, and elicits a cardinal ranking (e.g., 1-5) across types of carbon offset projects and the marginal propensity to pay for small additional features of a carbon offset projects.

The investor's answers to the information collection system for the optimal green share class recommendation engine, as well as the details of their other fund investments (to the scope and extent that the investor has uploaded or shared their investment history) are combined with the answers and investment details of other investors to generate a training database that the production engine uses to best predict both the portion of their fund 130 investment that should be green share class 131 vs. non-green share class 132, as well as how the green portion should be allocated among the various alternatives. For this calculation, a machine learning engine 316 the using recommendation engine 315 can predict answers based on the input data augmented by the outputs of an economic utility optimization to produce additional input parameters for the machine learning model.

In other words, the first step for a single investor involves calculating the optimal answers from an inferred utility function calibrated to their answers and data. The second step takes these economic predictions as additional parameters fed into the machine learning model trained on actual decisions by other investors for this fund and other funds. The first step computes the mathematically optimal decision while the second step adjusts for the actual decisions made by other people. Both results are reported to the investor to help them with their decision. Both approaches answer both questions, namely, a) how much of the allocation to the fund should be in non-green vs. green share classes? and (b) how should the green portion of their fund be allocated across the potentially multiple green share classes of the fund? The first method is likely to be a more normative and better answer to the question of how much green vs. non-green investment, while the second method is likely to be a more positive or empirical and better answer to the question of which green share classes should be allocated what portion of the total green budget.

In an example, a machine learning engine 316 was trained to implement a recommendation engine 315 to predict answers as described above. A survey of 150+ people was taken and filtered for respondents who (1) believe in climate change (2) are concerned about environmental issues (3) have a retirement plan (4) have made investments in equities and mutual funds, and (5) have a household income of $70k+. The survey had 2,438 matching participants, and responses were obtained from about 6.4% of them, which is more than sufficient for a statistically significant representative response.

The questions and responses were as follows:

How important an issue is climate change to you?

| | |
|---|---|
| Extremely important | 71 |
| Somewhat important | 67 |
| Neutral | 7 |
| Somewhat unimportant | 7 |
| Extremely unimportant | 5 |

Some mutual funds or exchange-traded funds (ETFs) are called “green” funds because they explicitly aim to benefit the environment in some way. Have you invested in a Green fund in the past?

| | |
|---|---|
| Yes, substantially | 6 |
| Yes, a little | 33 |
| No | 95 |
| I don't know or I'm not sure | 23 |

How important is it for you to invest in mutual funds or ETFs with a Green or sustainable objective?

| | |
|---|---|
| Extremely important | 18 |
| Somewhat important | 51 |
| Neutral | 46 |
| Somewhat unimportant | 28 |
| Extremely unimportant | 14 |

Let's say fund X is your favorite mutual fund. There is a Green version of Fund X that has the same holdings as Fund X but it also spends money to finance projects to reduce or remove carbon from the environment, by purchasing carbon offsets, to neutralize the carbon footprint of the companies whose stocks Fund X holds. Which fund are you more likely to purchase?

| | |
|---|---|
| Fund X (no carbon offsets) | 24 |
| Fund X Green (with carbon offsets) | 92 |
| Equally likely to purchase either one | 41 |

Consider these three different approaches to Green investing: exclude, pressure, and offset.

Approach 1 excludes all polluters from being bought or held in the portfolio.

Approach 2 purchases only polluters in the portfolio and actively pressures management to change.

Approach 3 does not exclude or pressure polluters but instead purchases carbon offsets to finance projects that improve the environment to neutralize the carbon footprint of its portfolio.

Assuming the return potential after fees and risks you are taking are equivalent, which Green approach do you find more appealing?

| | |
|---|---|
| Approach 1 - exclude | 53 |
| Approach 2 - pressure | 47 |
| Approach 3 - offset | 57 |

Which of the three approaches do you think would improve the environment most?

| | |
|---|---|
| Excluding polluters from stock portfolios would improve the | 55 |
| environment most. | |
| Purchasing and then pressuring polluters to change would improve | 46 |
| the environment most. | |
| Buying carbon credits to finance carbon-reduction projects would | 40 |
| improve the environment most. | |
| None of these would improve the environment. | 16 |

How do you think an investment portfolio that excludes polluters would likely perform compared to one that does not exclude them?

| | |
|---|---|
| The exclusionary portfolio would likely make less money and | 35 |
| have less risk. | |
| The exclusionary portfolio would likely make less money and | 91 |
| have more risk. | |
| The exclusionary portfolio would likely make more money and | 18 |
| have less risk. | |
| The exclusionary portfolio would likely make more money and | 13 |
| have more risk. | |

How do you think an investment portfolio that only purchases polluters, in order to try to pressure them to change, would likely perform compared to a portfolio that invests in both polluters and non-polluters?

| | |
|---|---|
| The portfolio that only purchases polluters would likely make less | 9 |
| money and have less risk than the more diversified portfolio. | |
| The portfolio that only purchases polluters would likely make less | 58 |
| money and have more risk than the more diversified portfolio. | |
| The portfolio that only purchases polluters would likely make more | 48 |
| money and have less risk than the more diversified portfolio. | |
| The portfolio that only purchases polluters would likely make more | 42 |
| money and have more risk than the more diversified portfolio. | |

How much would you be willing to pay per year to purchase carbon offsets to neutralize the carbon footprint of your investment in a mutual fund?

| | |
|---|---|
| 0% per year | 39 |
| Up to 0.10% per year, or $10 per year for a $10,000 investment | 40 |
| Up to 0.20% per year, or $20 per year for a $10,000 investment | 25 |
| Up to 0.50% per year, or $50 per year for a $10,000 investment | 23 |
| Up to 1.00% per year, or $100 per year for a $10,000 investment | 17 |
| Up to 2.00% per year, or $200 per year for a $10,000 investment | 5 |
| Up to 5.00% per year, or $500 per year for a $10,000 investment | 6 |
| More than 5.00% per year | 2 |

Some projects are avoidance or nature-based, such as reducing deforestation, and some are removal or technology-based, such as direct air capture to absorb carbon back from the atmosphere. If they cost the same amount per metric ton of carbon either avoided or removed, which would you prefer?

| | |
|---|---|
| For the same price, I would prefer nature-based carbon offsets | 112 |
| For the same price, I would prefer technology-based carbon offsets | 43 |

Suppose that the price of technology-based carbon offsets is $10 per metric ton of carbon. What is the most you would pay to get nature-based carbon offsets instead? 114 Responses

Suppose that the price of nature-based carbon offsets is $10 per metric ton of carbon. What is the most you would pay to get technology-based carbon offsets instead? 43 Responses

Suppose nature-based offsets cost about $4 per metric ton of carbon while tech-based offsets cost about $1 per metric ton of carbon. At these prices, how would you prefer to decarbonize your portfolio?

| | |
|---|---|
| Entirely with tech-based offsets | 23 |
| About 25% nature-based, 75% tech-based offsets | 62 |
| About 50% nature-based, 50% tech-based offsets | 50 |
| About 75% nature-based, 25% tech-based offsets | 15 |
| Entirely with nature-based offsets | 7 |

Now suppose nature-based offsets cost about $1 per metric ton of carbon while tech-based offsets cost about $4 per metric ton of carbon. At these prices, how would you prefer to decarbonize your portfolio?

| | |
|---|---|
| Entirely with tech-based offsets | 2 |
| About 25% nature-based, 75% tech-based offsets | 13 |
| About 50% nature-based, 50% tech-based offsets | 38 |
| About 75% nature-based, 25% tech-based offsets | 48 |
| Entirely with nature-based offsets | 56 |

Next, seven different machine learning algorithms were run to try to predict the answers to three different questions:
Q9: most you would pay to decarbonize (absolute question type)
Q13: portion in nature-vs-tech offsets if nature cost 4× tech (relative question type)
Q14: portion in nature-vs-tech offsets if tech cost 4× nature (conceptional question type)

Each ML run used all responses from all subjects, except the target variable.

The ML algorithms tested on the selected questions were: (1) a Decision Tree, (2) Gradient Boosted Trees using an ensemble of trees trained with gradient boosting (3) Linear Regression prediction from linear combinations of features (4) a Nearest Neighbor predictor from nearest neighboring examples (5) a Neural Network (6) a Random Forest predictor from Breiman-Cutler ensembles of decision trees and (7) a Gaussian Process predictor using a Gaussian process prior over functions.

The metric used to decide the efficacy of each ML algorithm was the coefficient of determination (R\hat{ }2), or the fraction of variance that was explained by the algorithm. The higher this number, the better the model. Table 1 shows the results, where the rows are the question being used as the target variable (Q9, Q13, or Q14) and the columns are the seven types of machine learning algorithms, with R\hat{ }2 for each combination:

TABLE 1

| | DecisionTree | GradientBoostedTrees | LinearRegression | NearestNeighbors | NeuralNetwork | RandomForest | GaussianProcess |
|---|---|---|---|---|---|---|---|
| 9 | 0.0 [symbol] 1258 | 0.303478 | 0.254825 | 0.161442 | 0.148847 | 0.21863 [symbol] | 0. [symbol] 83147 [symbol] |
| 13 | 0.243772 | 0.354372 | 0.318 [symbol] 34 | 0.42028 | 0.7812 [symbol] 3 | 0.33 [symbol] 62 | 0.038 [symbol] 338 |
| 14 | −0.1 [symbol] 9 | 0.1 [symbol] 1468 | 0.1424 [symbol] 7 | 0.270 [symbol] 75 | −0.03878 [symbol] | 0.419 [symbol] 72 | 0.2 [symbol] 953 |

[symbol]

indicates data missing or illegible when filed

Results showed that the Random Forest ML was best, having above 20% R-squared in each of the three questions. Neural Networks did very well on Q13 but not on Q14, suggesting overfitting. Gradient boosted trees, linear regression, and nearest neighbors performed reasonably well.

Table 1 shows all “in-sample” evaluations. Next, “out-of-sample” evaluations were run using leave-one-out cross-validation. For each respondent, the ML was trained on all other respondents, and then the ML model is run to predict for the elided respondent. This required training 157 models rather than one, however it was found that this is an advantageously useful implementation, justifying the time-consuming ML training. Results are shown in Table 2:

TABLE 2

| | GradientBoostedTrees | LinearRegression | NearestNeighbors | RandomForest |
|---|---|---|---|---|
| 9 | −0.00673302 | 0.133222 | 0.0163657 | 0.00680073 |
| 13 | 0.104111 | 0.0618412 | 0.0326594 | 0.375655 |
| 14 | 0.0775698 | 0.120549 | 0.13235 | 0.121505 |

As shown in Table 2, of the 4 selected reasonably performing ML models from the in-sample results, the Random Forests ML performed best, with exceptional performance for key allocation decisions (q13 and q14). While linear regression performed better out of sample for Q9, it is expected that with more data, Random Forests will produce better predictions and match that as the model updates.

Accordingly, in an implementation, the system includes a machine learning trained green share class recommendation engine. The green share class recommendation engine can include a Random Forests trained prediction engine, Gradient boosted trees trained prediction engine, linear regression trained prediction engine, or nearest neighbors trained prediction engine. In an advantageous implementation the green share class recommendation engine comprises a Random Forests trained algorithm.

The service provider 112 provides services for all of the green share classes 131 offered by the fund, and a service administration fee is identical across all of the share classes. As a result, the service fees across different green share classes 131 differ only due to the decarbonization fees for the specific offset constraints of each share class. The optimal green share class recommendation engine 315 is thus able to provide an unbiased and objective answer to the investor allocation question. In all cases, of course, the recommendation engine is an option for each investor and is neither binding nor restrictive: investors can choose to put less or more into green vs. non-green share classes, and in any proportion they wish.

In an implementation, the system can be configured to accurately calculate the geographic distribution of carbon pollution in the portfolio. For example, the system can be configured to obtain carbon emission MTCO2e information attributable to one or more entities in a fund and estimate carbon emissions of the underlying companies. Accordingly, the system can calculate the carbon emissions as disclosed herein on a per entity or even per sub-entity basis (e.g. parent company/subsidiary company, joint ventures, partnership, company/agent company) and geolocate carbon emissions to jurisdictions or locations for that company. Similarly, in an implementation, the system can be configured to accurately producing a carbon credit portfolio to match a geographic distribution of carbon pollution for a target portfolio.

One exemplary advantage of the platform is it provides technological tools to estimate carbon emissions of the underlying companies held in an investment portfolio without daily reconciliation, which would require carbon credits must be purchased and retired every day to offset these emissions on a regular basis, considering inflows into and outflows from the “green” share class. Further, absent the current service provider platform, these activities would need to be structured as a service fee to be able to offer a “green” share class, as share classes for a mutual fund can only differ by fees. This would necessitate that the purchase price of the credits and immediate retirement to be recorded and accounted for as a service fee that accrues daily to holders of the “green” share class, where this fee has a known ex-ante cap which may limit how many carbon credits are purchased.

Another exemplary advantage is that the platform offers investors the ability to invest in funds to a desired carbon neutral level. Absent the platform, an individual investor concerned about the carbon footprint of their fund investments would need to purchase carbon offsets themselves. As will be appreciated, doing so would likely (1) be more costly as the benefits of scale a fund offers are no longer present, (2) increase the uncertainty of the quality of carbon credit purchases as the investment manager brings expertise and analytics that an individual investor may not have in evaluating carbon credit quality and (3) present challenges in estimating accurately the amount of carbon credits that need to be purchased as the investment manager brings analytics and has access to real time portfolio holdings to better estimates the carbon emission of the holdings.

Another exemplary advantage of the service provider platform is that investment managers do not need to launch a separate “green” fund for investors who prioritize socially responsible investing. The service platform provides the same and improved benefits as compared to a new “green” mutual fund that utilizes carbon credits, which would be more costly as the lack of scale tied to an existing mutual fund with assets would lead to higher mutual fund expenses, many of which include fixed fees.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system or even a group of multiple computer systems. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

### Illustrative User Interface Use Cases

FIGS. 6A-6B represent embodiments of graphical user interfaces for a service provider network platform and applications with at least one of the various embodiments. In at least one of the various embodiments, user interfaces other than user interfaces described herein may be employed without departing from the spirit and/or scope of the claimed subject matter. Such user interfaces may have more or fewer user interface elements which may be arranged in various ways. In some embodiments, user interfaces may be generated using web pages, mobile applications, application programming interfaces, or the like. In at least one of the various embodiments applications and servers can include processes and/or API's for generating user interfaces as described herein.

It will be understood by those skilled in the art that various modifications, combinations, sub-combinations and alterations may occur depending on design requirements and other factors insofar as they are within the scope of the appended claims or the equivalents thereof.

1. A system for providing a service provider platform comprising:
a machine learning engine;
an investor interface comprising a machine learning trained recommendation engine, the recommendation engine being configured to predict an optimal green share class allocation for a security portfolio
a carbon offset calculation tool application, the carbon offset calculation tool application being configured to at least:
a) for each day D in a period, obtain a plurality of security holdings of a fund as a list, the list comprising, for each security, a Security ID, Shares Held by Fund, Total Shares Outstanding of This Security, and Portion of Enterprise Market Cap (MC) Represented by this Security;
b) calculate a Portion of the Total Enterprise MC owned by the fund by a formula the Shares Held by Fund divided by the Total Shares Outstanding of This Security times the Portfolio of Enterprise MC in this Security;
c) obtain an amount of carbon emissions for the enterprise associated with the security;
d) compute a portion of carbon emissions for which the fund is responsible by a Portion of the Total Enterprise MC owned by the fund times the amount of carbon emissions for the enterprise;
e) sum the portion of carbon emissions for which the fund is responsible for all the security holdings in the fund and divide the sum by a million;
f) compute the daily footprint by multiplying the divided sum of e) by the fraction of fund assets held by the given green share class; and
g) calculate the average of the daily fund footprint for each day D of the period.

2. The system of claim 1, wherein the investor interface is configured to at least:
present and obtain answers from an investor for a plurality of questions; and
output a green share class recommendation from the recommendation engine based on the answers.

3. The system of claim 1, wherein the investor interface configured to at least:
present and obtain answers from the investor for the plurality of questions comprising:
an absolute question type for a carbon offset project cost,
a relative question type for a carbon offset preference between two carbon project offsets, and
a conceptual question type for ranking carbon offset project types.

4. The system of claim 3, wherein the system is configured to at least:
generate a training database using the answers to the questions from a plurality of investors; and
train the recommendation engine on the training database using the machine learning engine.

5. The system of claim 2, wherein the system is configured to at least:
generate a training database using the answers to the questions from a plurality of investors; and
train the recommendation engine on the training database using the machine learning engine.

6. The system of claim 5, wherein the prediction engine comprises a green share class recommendation engine selected from the group consisting of: a Random Forests trained prediction engine, a Gradient boosted trees trained prediction engine, a linear regression trained prediction engine, or a nearest neighbors trained prediction engine.

7. The system of claim 6, wherein the green share class recommendation engine comprises the Random Forests trained prediction engine.

8. The system of claim 1, wherein the recommendation engine is configured to output a green share class recommendation comprising: a share class allocation across green share classes and non-green share classes.

9. The system of claim 1 wherein the system comprises:
an interface operatively connected to one or more carbon registries, wherein the system is configured to track carbon credit transactions including carbon offset retirement.

10. The system of claim 9 wherein the carbon credit transactions include transactions recorded on a distributed immutable ledger.

11. A method for a service provider platform comprising a carbon offset calculation tool application, the method comprising:
a) for each day D in a period, obtaining a plurality of security holdings of a fund as a list, the list comprising, for each security, a Security ID, Shares Held by Fund, Total Shares Outstanding of This Security, and Portion of Enterprise Market Cap (MC) Represented by this Security;
b) calculating a Portion of the Total Enterprise MC owned by the fund by a formula the Shares Held by Fund divided by the Total Shares Outstanding of This Security times the Portfolio of Enterprise MC in this Security;
c) obtaining an amount of carbon emissions for the enterprise associated with the security;
d) computing a portion of carbon emissions for which the fund is responsible by a Portion of the Total Enterprise MC owned by the fund times the amount of carbon emissions for the enterprise;
e) summing the portion of carbon emissions for which the fund is responsible for all the security holdings in the fund and divide the sum by a million;
f) computing the daily footprint by multiplying the divided sum of e) by the fraction of all the security holdings of the fund held by the given green share class; and
g) calculating the average of the daily fund footprint for each day D of the period.

12. The method of claim 11, wherein the system comprises an investor interface comprising a machine learning trained recommendation engine configured to predict an optimal green share class allocation for a security portfolio; the method comprising:
presenting and obtaining answers from an investor via the investor interface for a plurality of questions; and
outputting a green share class recommendation from the recommendation engine based on the answers.

13. The method of claim 12, further comprising:
presenting and obtaining the answers from the investor for the plurality of questions comprising:
an absolute question type for a carbon offset project cost,
a relative question type for a carbon offset preference between two carbon project offsets, and
a conceptual question type for ranking carbon offset project types.

14. The method of claim 13, wherein the system comprises a machine learning engine, the method further comprising:
generating a training database using the answers to the questions from a plurality of the investors; and
training the recommendation engine on the training database using the machine learning engine.

15. The method of claim 12, wherein the system comprises a machine learning engine, the method further comprising:
generating a training database using the answers to the questions from a plurality of the investors; and
training the recommendation engine on the training database using the machine learning engine.

16. The method of claim 15, wherein the method comprises training the recommendation engine with a machine learning algorithm selected from the group consisting of: a Random Forests algorithm, a Gradient boosted trees algorithm, a linear regression algorithm, or a nearest neighbors algorithm.

17. The method of claim 16, wherein method comprises training the recommendation engine on the Random Forests algorithm.

18. The method of claim 11, wherein the system comprises an investor interface comprising a machine learning trained recommendation engine configured to predict an optimal green share class allocation for a security portfolio, and the method comprises: outputting a green share class recommendation from the recommendation engine comprising: a share class allocation across green share classes and non-green share classes.

19. The method of claim 11 wherein the system comprises an interface operatively connected to one or more carbon registries, and the method further comprises:
tracking carbon credit transactions including carbon offset retirement.

20. The method of claim 19 wherein the method further comprises tracking the carbon credit transactions recorded on a distributed immutable ledger.
